(19) United States
(12) Patent Application Publication
(10) Pub. No.: US 2024/0006696 A1
(43) Pub. Date: Jan. 4, 2024

(54) BATTERY ARRAY AND BATTERY ASSEMBLY

(71) Applicant: FORD GLOBAL TECHNOLOGIES, LLC, Dearborn, MI (US)

(72) Inventors: Bin YIN, Nan Jing (CN); Steven SHI, NanJing (CN); Jim LIU, Nanjing (CN); Bo MIAO, Nanjing (CN)

(21) Appl. No.: 18/341,132

(22) Filed: Jun. 26, 2023

(30) Foreign Application Priority Data
Jun. 30, 2022 (CN) 2022216648847

(51) Int. Cl. H01M 50/204; B60L 50/64; B60L 50/60; H01M 10/42

(52) U.S. Cl. CPC H01M 50/204; B60L 50/64; B60L 50/66; H01M 10/425; H01M 2220/20

(57) ABSTRACT

A battery assembly may include a battery array. The battery array may include at least one battery module that includes a plurality of battery cells arranged in a first direction and disposed between opposite end plates. At least one reinforcing member may be at least partially disposed between two adjacent battery cells of the battery module. The battery assembly includes a plurality of battery arrays arranged on a tray. By providing the reinforcing member, the battery array simplifies the structure while improving the mechanical strength, and has better volume utilization rate inside housing when constructing the battery assembly.

### CROSS-REFERENCE TO RELATED APPLICATIONS

This disclosure claims priority to Chinese Patent Application No. 2022216648847, which was filed on Jun. 30, 2022 and is incorporated herein by reference in its entirety.

### TECHNICAL FIELD

The present disclosure generally relates to the technical field of batteries, and more specifically relates to a battery array and a battery assembly including the battery array.

### BACKGROUND

With the development of consumer demand for fuel saving and environmental protection in the current market, various new energy vehicles, including but not limited to pure electric vehicles (BEVs), hybrid electric vehicles (HEVs), and plug-in hybrid electric vehicles (PHEVs), are becoming increasingly popular. These new energy vehicles will become one of the important trends in the future development of the automotive industry due to their advantages in fuel conservation, environmental protection, and economy.

Most new energy vehicles have a battery assembly typically composed of multiple battery arrays to provide power to an electric motor of the vehicle, thereby providing driving power to the vehicle either individually or together with a vehicle engine. The number of the battery arrays that the battery assembly can accommodate is closely related to endurance capacity of the new energy vehicle.

Therefore, there is still a need to enhance volume utilization rate in the battery array and the battery assembly.

### SUMMARY

In this context, inventors of the present disclosure realized that it is desirable to design a battery array structure that can enhance space utilization rate inside a housing of the battery assembly and has good structural strength.

The present disclosure summarizes various aspects of the embodiments and should not be used to limit the protection scope of the present disclosure. Other implementations are contemplated in accordance with the techniques described herein, as will be apparent upon examination of the following drawings and detailed description, and such implementations are intended to be within the scope of this application.

An advantage of the present disclosure is that it provides an enhanced battery array, which can reduce the number of cross members and side plates, enhance the space utilization rate inside the housing of the battery assembly, reduce the wiring routing length and complexity, and has good mechanical strength. At the same time, production expense and assembly complexity of the battery array will not be significantly affected compared to existing designs.

According to one aspect of the present disclosure, provided is a battery array that includes:
at least one battery module including a plurality of battery cells arranged in a first direction and disposed between opposite end plates; and
at least one reinforcing member at least partially disposed between two adjacent battery cells.

According to an embodiment of the present disclosure, the battery array further includes a fixing structure for fixing the battery module, wherein the fixing structure includes a tensioning band that circumferentially surrounds the battery module and/or a fixing frame that abuts sides of the battery module.

According to an embodiment of the present disclosure, the reinforcing member is a reinforcing plate disposed between two adjacent battery cells and having a cavity, in which electronic component is arranged.

According to an embodiment of the present disclosure, the reinforcing member is a bracket at least partially disposed between two adjacent battery cells and extending in the first direction or in a second direction that intersects or is perpendicular to the first direction, on which electronic component is arranged.

According to an embodiment of the present disclosure, the adjacent battery cells among the plurality of battery cells are bonded together.

According to an embodiment of the present disclosure, the end plates and/or the reinforcing member are fixed to a tray of a battery assembly.

According to an embodiment of the present disclosure, the reinforcing member has a height smaller than that of the battery cell in a vertical direction, and the reinforcing member is clamped by two battery cells and forms an upward extending depression at a bottom; and
the tray has an upward extending protrusion, the reinforcing member is fixed to the protrusion, and the protrusion has a shape that adapts to that of the depression.

According to an embodiment of the present disclosure, the bracket includes a plate extending between two adjacent battery cells and a connecting portion connected to the tray, wherein the plate has a height smaller than that of the battery cell in a vertical direction, and the plate is clamped by two battery cells and forms a downward extending depression at a top to accommodate the electronic component.

According to another aspect of the present disclosure, provided is a battery assembly including:
a tray;
a plurality of battery arrays mounted to the tray, each of the plurality of battery arrays including at least one battery module that includes a plurality of battery cells arranged in a first direction and disposed between opposite end plates;
at least one reinforcing member at least partially disposed between two battery cells;
a fixing structure for fixing the battery module; and
a cover plate fixed to the tray to accommodate the plurality of battery arrays.

According to an embodiment of the present disclosure, the reinforcing member is clamped by two battery cells and forms a depression at a bottom;
the tray has a protrusion that protrudes upwards in a longitudinal direction;
the reinforcing member is fixed to the protrusion and the protrusion has a shape that adapts to that of the depression.

### BRIEF DESCRIPTION OF THE DRAWINGS

For a better understanding of the present disclosure, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further in the figures, like reference numerals refer to like parts throughout the different figures.

FIG. 1 is a schematic diagram of a battery array according to an embodiment of the present disclosure;

FIG. 2 is a schematic diagram of a battery assembly according to an embodiment of the present disclosure, which shows a structural schematic diagram of the battery assembly having multiple battery arrays;

FIG. 3 is a schematic diagram of a reinforcing member of a battery array according to another embodiment of the present disclosure;

FIG. 4 is a top view schematic diagram of a crossbeam structure of a reinforcing member of the present disclosure shown in FIG. 3;

FIG. 5 is a schematic diagram of a reinforcing member of a battery array according to another embodiment of the present disclosure;

FIG. 6 is a schematic diagram of a reinforcing member of a battery array according to yet another embodiment of the present disclosure.

### DETAILED DESCRIPTION

Although the present disclosure can be implemented in various forms, some exemplary and non-limiting embodiments are shown in the accompanying drawings and will be described below, it should be understood that these will be considered examples of the present disclosure and are not intended to limit the present disclosure to the specific embodiments described.

In order to further enhance the volume utilization rate of the battery assembly and reduce the wiring routing length in the battery assembly, the present disclosure provides a battery array 1.

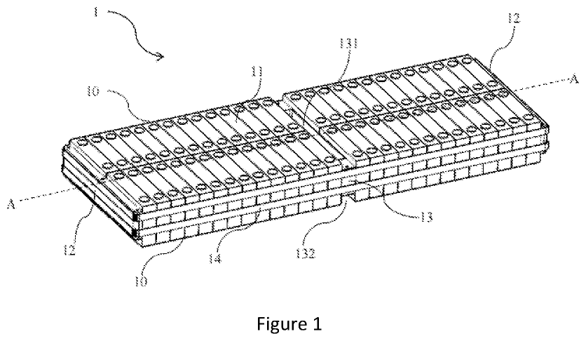

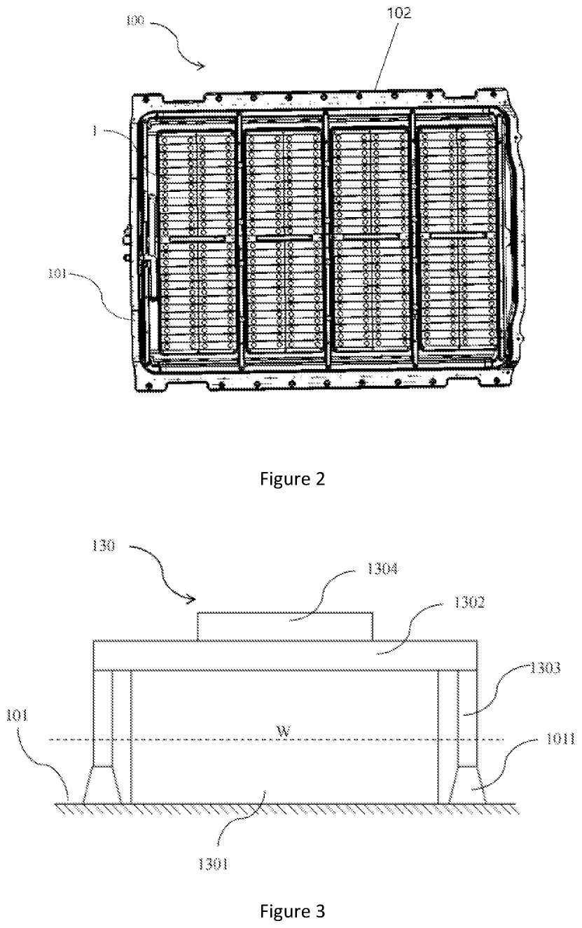

As shown in FIG. 1, in a non-limiting embodiment of the present disclosure, the battery array 1 includes two sets of battery modules 10. Each set of battery modules 10 includes a plurality of battery cells 11. The plurality of battery cells 11 are arranged between opposite end plates 12 along an axis A in a first direction, and the adjacent battery cells 11 are bonded to each other by an adhesive. In an embodiment of the present disclosure, the adhesive can be one or more of vinyl acetate resin, acrylic resin, chlorinated rubber, and epoxy resin. The end plate 12 can be fastened to a tray 101 of a battery assembly 100 shown in FIG. 2 with fasteners. The battery array 1 also has a reinforcing member. In this embodiment, the reinforcing member is specifically embodied as a reinforcing plate 13, which is inserted between two adjacent battery cells 11. In the embodiment shown in FIG. 1, only one reinforcing plate 13 is provided, but it can be understood that multiple reinforcing plates 13 can be inserted into multiple positions between any two adjacent battery cells 11 of the battery array 1 as needed.

Continuing with reference to FIG. 1, the reinforcing plate 13 has a cavity 131 that opens at an upper end to accommodate an electronic component of the battery array 1 (not shown). In a non-limiting embodiment, the electronic component is an information collection component of the battery array 1. The information collection component can be used to detect information such as voltage and temperature of each battery cell 11 or battery module 10, and send relevant information to a battery control unit, and can receive instructions from the battery control unit to collect specific information. The information collection component can be positioned in the cavity 131 through various methods such as fasteners, adhesives, and clamping structures. In existing battery structures, the information collection component and the battery control unit are typically arranged together at a specific location on the tray 101 of the battery assembly 100, such as on the outside of one of the end plates 12. However, this arrangement results in a longer distance between the information collection component and the battery cell 11 and the battery module 10, resulting in a longer and more complex wiring routing. For example, when the information collection component is provided on one side, if it is necessary to collect information about battery cells on the other side, the wiring needs to span the entire length of the battery array in direction A. In this embodiment, by arranging the information collection component in the cavity 131 of the reinforcing plate 13, the information collection component is arranged closer to the battery array 1 or battery cell 11, thereby reducing the wiring routing complexity. In this embodiment, the reinforcing plate 13 is arranged in the middle of the battery array 1 in direction A. Through this arrangement, the two battery cells 11 holding the reinforcing plate 13 are close to the reinforcing plate 13, and the distance between the battery cells 11 close to the end plates 12 on both sides, which are farthest from the reinforcing plate 13, and the information collection component is only half of the overall length of the battery array 1 in direction A. And due to the symmetrical arrangement of the battery cells 11 on both sides of the reinforcing plate 13, the wiring routing can also be carried out symmetrically, thereby reducing the complexity of wiring routing. It can be understood that in other embodiments, multiple reinforcing plates 13 can be provided in the battery array 1, such as multiple reinforcing plates 13 may be provided evenly spaced in an equidistant manner along the overall length of direction A. In this way, multiple information collection components can be used to collect information from adjacent battery cells 11, further reducing the complexity of wiring routing. In addition, by providing the reinforcing plate 13 in the battery array 1, additional reinforcing structures are formed between the end plates 12 on both sides of the battery array 1, which reduces the length in the first direction A of the battery array 1 directly held by the end plates 12 on both sides, thereby making the overall structure of the battery array 1 more stable.

Continuing with reference to FIG. 1, in this embodiment, the reinforcing plate 13 has a height smaller than that of the battery cell 11 in a vertical direction. Therefore, when the reinforcing plate 13 is sandwiched between two adjacent battery cells 11, an upward extending depression 132 is formed between the reinforcing plate 13 and the adjacent battery cells 11 at a bottom. The depression 132 can be adapted in shape to a raised rib on the tray 101 of the battery assembly 100, so that the reinforcing plate 13 is firmly fixed to the raised rib of the tray 101 through fasteners. It can be understood that in other embodiments, the height of the reinforcing plate 13 in the vertical direction can also be greater than the height of the battery cell 11. When the reinforcing plate 13 is sandwiched between two adjacent battery cells 11, an upper end of the reinforcing plate 13 protrudes above the battery cell 11 and a protrusion (not shown in the figure) is formed. The protrusion can be received through a cavity arranged on the inside of a cover plate of the battery assembly. The cavity is arranged to adapt to the shape of the protrusion, so that the lower part of the reinforcing plate 13 is firmly fixed on the tray 101, while the upper part is further fixed by the cover plate, which make the overall structure more stable.

In an embodiment of the present disclosure, the battery array 1 also has a fixing structure for holding and fixing the battery module 10. In this embodiment, the fixing structure is a tensioning band 14 that is fixed circumferentially around the periphery of one or more battery modules 10 of the battery array 1. In this embodiment, there are two tensioning bands 14. It is understood that the number of tensioning bands 14 can be provided according to the needs of the clamping force. In this embodiment, the tensioning band 14 relies on its own tensioning force to fasten two battery modules 10 arranged in parallel together. In addition, in another embodiment, the tensioning band 14 can also be a band connected through fixing parts, which are respectively arranged at both ends of the tensioning band 14, and the connection between the fixing parts causes the tensioning band 14 to form a circular structure. The fixing parts can be connected together through one or more of various connection methods such as bolt connection, snap connection, etc. In addition, in other embodiments, the fixing structure can also be a fixing plate arranged on the tray 101 of the battery assembly 100. The fixing plate can be fixed to the tray 101 by fasteners or welding and abut with sides of the battery module 10 to enhance the stability of the battery module 10. It can be understood that other forms of fixing structures, such as the fixing methods of battery modules such as fixing bracket and fixing tray, can also be applied to the fixing of the battery module 10 of the present disclosure.

Next, the battery assembly 100 is formed by placing multiple battery arrays 1 as shown in FIG. 1 in the tray 101 of the battery assembly 100 and fixedly connecting a cover of the battery assembly (not shown in the figure) to a flange 102 of the tray 101 of the battery assembly 100 as shown in FIG. 2. The tray 101 and the cover establish an enclosure that accommodates various hardware and electronic products of the battery assembly 100, such as, but not limited to, the battery array 1, the information collection component, a battery management component, and the like. The battery assembly 100 is an example type of battery assembly for electrified vehicles. The battery assembly 100 may include a high voltage battery pack capable of outputting electrical power to operate a motor and/or generator. Other types of energy storage and/or output devices can also be used to provide electrical power to the electrified vehicles. In this embodiment, the battery assembly 100 includes four battery arrays 1. It can be understood that the battery assembly 100 can include more or fewer battery arrays 1 as needed. The above four battery arrays 1 are provided as examples only and do not limit any specific number of the battery arrays 1. The tray 101 of the battery assembly 100 has a plurality of raised ribs to fit with the bottom shape of the battery array 1, enabling the battery array 1 to be firmly positioned on the tray 101 of the battery assembly 100. The end plate 12 and reinforcing plate 13 of the battery array 1 can be fastened to a bottom plate or the raised ribs of the tray 101 through fasteners to secure the battery array 1 to the tray 101.

Next, as shown in FIG. 3, a schematic diagram of another embodiment of the reinforcing member of the present disclosure is shown. In this embodiment, the reinforcing member is specifically embodied as a reinforcing bracket 130, which includes an insertion portion 1301. In this embodiment, the insertion portion 1301 is of a plate-shaped structure with a crossbeam 1302 arranged on its upper end. The crossbeam 1302 has a length greater than a width of the battery array 1 and extends in a second direction different from the axis A in the first direction. In this embodiment, the second direction is a lateral direction W perpendicular to the first direction. Legs 1303 extending vertically downward from both ends of the crossbeam 1302 can be secured to the raised ribs 1011 on the tray 101 of the battery assembly 100 by fasteners. In another embodiment, the reinforcing bracket 130 may have longer legs 1303 to allow it to be directly secured to the bottom plate of the tray 101.

Continuing with reference to FIG. 3, the information collection component 1304 of the battery array 1 is arranged on the crossbeam 1302. The information collection component 1304 can be connected to the crossbeam 1302 through a mounting structure (such as mounting holes and fasteners). In another embodiment, the information collection component 1304 can also be bonded to an upper surface of the crossbeam 1302 through an adhesive. The insertion portion 1301 of the reinforcing bracket 130 can be inserted between two adjacent battery cells 11 of the battery array 1, so that the information collection component 1304 is adjacent to the battery array 1. It can be understood that the insertion portion 1301, the crossbeam 1302, and the legs 1303 can be different components that are connected and combined through fasteners or adhesives, or they can be integrally formed integral components.

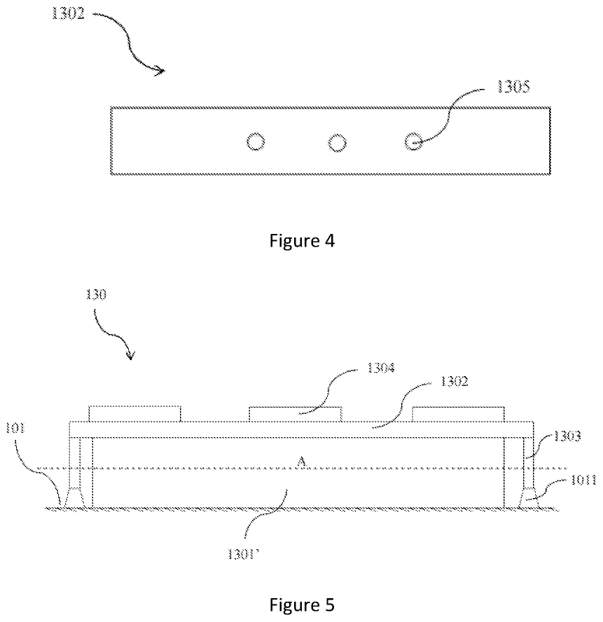

From the top view of the crossbeam 1302 shown in FIG. 4, it can be seen that an upper surface of the crossbeam 1302 has a plurality of mounting holes 1305 through which the information collection component 1304 can be fixed on the reinforcing bracket 130 so as to be adjacent to the battery array 1 or the battery cell 11. Since the information collection component 1304 is installed and positioned through the crossbeam 1302, it is not necessary to provide a cavity on the insertion portion 1301 to accommodate the information collection component 1304, making it possible to have a thinner thickness and more convenient to insert between the corresponding battery cells 11 as needed to obtain information. The insertion portion 1301 inserted between the battery cells 11 also has the function of strengthening the structural stability of the battery array 1, and further enhances the structural strength of the battery array 1 and the tray 101 fixation by fixing the two legs 1303 to the tray 101 of the battery assembly 100.

In another embodiment of the present disclosure shown in FIG. 5, unlike the embodiment shown in FIG. 3, the insertion portion 1301′ of the reinforcing bracket 130 extends in direction A, that is, extends in the first direction. In this embodiment, the insertion portion 1301′ is inserted between the two sets of battery modules 10 shown in FIG. 1, that is, the insertion portion 1301′ is jointly held by the two sets of battery modules 10. The insertion portion 1301′ can extend the entire length of the battery module 10 in direction A or only a portion of the length of the battery module 10. In this embodiment, multiple information collection components 1304 of the battery array 1 are arranged on the crossbeam 1302 at intervals to collect information from adjacent battery cells 11. It is understood that in other embodiments, more or fewer information collection components can be provided as needed. The reinforcing bracket 130 also includes legs 1303 extending vertically downward from both ends of the crossbeam 1302, and the legs 1303 on both sides are respectively fixed to the outside of the end plates 12 on both sides of the battery array 1 by welding or fasteners. By extending the insertion portion 1301′ in direction A, the contact area between the insertion portion 1301′ and the battery module 10 is increased, and the structural stability of the battery array 1 is thus increased.

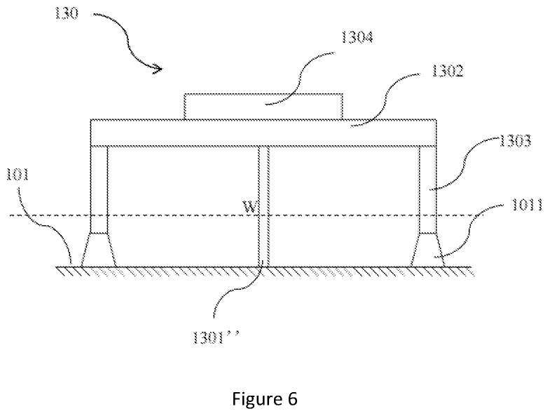

Referring to yet another embodiment of the present disclosure shown in FIG. 6, unlike the embodiment shown in FIG. 5, although the insertion portion 1301″ also extends in direction A, that is, extends in the first direction, and is inserted between the battery modules 10 in this embodiment, the crossbeam 1302 above the insertion portion 1301″ still extends in the second direction W perpendicular to the first direction in this embodiment, thereby spanning the width of the battery array 1 in the second direction and being fixed to the trays 101 on both sides of the battery array 1 or to the raised ribs 1011 through the legs 1303. This arrangement, on the one hand, achieves the purpose of strengthening the mechanism of the battery array 1 by extending a longer length of the insertion portion 1301″ in the first direction A, and on the other hand, makes the crossbeam 1302 extending in the shorter second direction W easier and less expensive to install.

It should be understood that, where it is technically possible, the technical features listed in relation to different embodiments can be combined with each other to form further embodiment within the scope of the present disclosure. In addition, the specific examples and embodiments described herein are non-limiting, and corresponding modifications can be made to the structure, dimensions, and materials described above without departing from the protection scope of the present disclosure.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above embodiments, especially any “preferred” embodiments, are possible examples of implementations, merely set forth for a clear understanding of the principles of the present disclosure. Many variations and modifications can be made to the above embodiments without substantially departing from the spirit and principles of the technology described herein. All such modifications are intended to be included within the scope of the present disclosure.

1. A battery array comprising:
at least one battery module comprising a plurality of battery cells arranged in a first direction and disposed between opposite end plates;
a reinforcing member at least partially disposed between two adjacent battery cells of the plurality of battery cells; and
an electronic component arranged on or within the reinforcing member.

2. The battery array according to claim 1, further comprising a fixing structure for fixing the at least one battery module, wherein the fixing structure comprises a tensioning band that circumferentially surrounds the at least one battery module and/or a fixing frame that abuts sides of the at least one battery module.

3. The battery array according to claim 1, wherein the reinforcing member is a reinforcing plate disposed between the two adjacent battery cells and having a cavity.

4. The battery array according to claim 3, wherein the electronic component is an information collection component arranged within the cavity.

5. The battery array according to claim 3, wherein the reinforcing plate has a height smaller than that of the two adjacent battery cells in a vertical direction, and the reinforcing plate is clamped by the two adjacent battery cells and forms an upward extending depression at a bottom.

6. The battery array according to claim 1, wherein the reinforcing member is a bracket at least partially disposed between the two adjacent battery cells and extending in the first direction or in a second direction that intersects or is perpendicular to the first direction.

7. The battery array according to claim 6, wherein the electronic component is an information collection component arranged on a crossbeam of the bracket.

8. The battery array according to claim 7, wherein the crossbeam includes a plurality of mounting holes through which the information collection component is fixed to the crossbeam.

9. The battery array according to claim 1, wherein the opposite end plates and/or the reinforcing member are fixed to a tray of a battery assembly that comprises the battery array.

10. The battery array according to claim 9, wherein the reinforcing member has a height smaller than that of the two adjacent battery cells in a vertical direction, and the reinforcing member is clamped by the two adjacent battery cells and forms an upward extending depression at a bottom; and
the tray has an upward extending protrusion, and the reinforcing member is fixed to the upward extending protrusion, and the upward extending protrusion has a shape that adapts to that of the upward extending depression.

11. The battery array according to claim 1, wherein the two adjacent battery cells are bonded together.

12. A battery assembly comprising:
a tray;
a plurality of battery arrays mounted to the tray, each of the plurality of battery arrays comprising at least one battery module comprising a plurality of battery cells arranged in a first direction and disposed between opposite end plates;
a reinforcing member mounted to the tray and at least partially disposed between two adjacent battery cells of the plurality of battery cells; and
a fixing structure for fixing the at least one battery module.

13. The battery assembly according to claim 12, wherein the reinforcing member is clamped by the two adjacent battery cells and forms a depression at a bottom;
the tray has a protrusion that protrudes upwards in a longitudinal direction; and
the reinforcing member is fixed to the protrusion and the protrusion has a shape that adapts to that of the depression.

14. The battery assembly according to claim 13, wherein the reinforcing member is a reinforcing plate that includes a cavity.

15. The battery assembly according to claim 14, comprising an electronic component at least partially accommodated within the cavity.

16. The battery assembly according to claim 12, wherein the reinforcing member is a reinforcing bracket that includes an insertion portion positioned between the two adjacent battery cells or between the at least one battery module and a second battery module.

17. The battery assembly according to claim 16, wherein the reinforcing bracket includes a crossbeam arranged on an upper end of the insertion portion and a leg extending vertically downward from each end of the crossbeam.

18. The battery assembly according to claim 17, wherein the leg is secured to a raised rib of the tray.

19. The battery assembly according to claim 17, comprising an electronic component mounted to the crossbeam.

20. The battery assembly according to claim 19, wherein the electronic component is an information collection component.
